(19) United States
(12) Patent Application Publication
(10) Pub. No.: US 2025/0328790 A1
(43) Pub. Date: Oct. 23, 2025

(54) Method for Evaluating Measurement Data

(71) Applicant: Robert Bosch GmbH, Stuttgart (DE)

(72) Inventors: Noha El Gemayel, Rheinstetten (DE); Thomas Ulrich, Ilsfeld (DE)

(21) Appl. No.: 19/177,548

(22) Filed: Apr. 12, 2025

(30) Foreign Application Priority Data
Apr. 23, 2024 (DE) 10 2024 203 762.1

(51) Int. Cl. G06N 7/01; B60W 50/00

(52) U.S. Cl. CPC G06N 7/01; B60W 50/0098

(57) ABSTRACT

A method for evaluating measurement data of a vehicle includes (i) providing the measurement data, (ii) pre-processing the measurement data, (iii) creating a histogram for the pre-processed measurement data, (iv) providing a model of a probability distribution function, (v) estimating the probability distribution function obtained from the measurement data based on the provided model, (vi) providing search patterns, and (vii) eliminating measurement data while taking into account the search patterns.

This application claims priority under 35 U.S.C. § 119 to application no. DE 10 2024 203 762.1, filed on Apr. 23, 2024 in Germany, the disclosure of which is incorporated herein by reference in its entirety.

The disclosure relates to a method for evaluating measurement data and an assembly for carrying out the method. The disclosure further relates to a computer program and a machine-readable storage medium for carrying out the presented method.

### BACKGROUND

Autonomous driving systems must ensure the safety of the intended functionality as an essential safety aspect. A main component of the concept of Safety of the Intended Functionality (SOTIF), referred to herein as the SOTIF concept, is the validation in which a system is released based on a limited amount of data compared to the required error rates.

As an example: A sensor component within the autonomous driving system must satisfy an error rate of 10⁻⁵/h. This feature can be validated by performing only 5000 hr test runs. It cannot be expected that an error is actually observed within the validation time. Suitable validation procedures must therefore be introduced for this purpose. Statistical analysis methods are typically a measure for bridging the distance between the amount of data available and the error rates required.

When using statistical analysis methods, the following results are very valuable for the overall validation:
1. A calculation of specific possibilities based on the observed measurement data.
2. An identification of critical and less critical scenarios in order to analyze safety-related scenarios and eliminate remaining risks in the system.

### SUMMARY

Against this background, a method and an assembly are presented. Furthermore, a computer program and a machine-readable storage medium having the features set forth below are presented. Embodiments arise from the description.

The presented method serves to evaluate measurement data for a vehicle and comprises the following steps:

providing the measurement data,
pre-processing the measurement data,
creating a histogram for the pre-processed measurement data,
providing a model of a probability distribution function,
estimating the probability distribution function obtained from the measurement data based on the provided model,
providing search patterns,
eliminating measurement data while taking into account the search patterns.

Probability distribution functions are used, which can be derived from the extreme value theory, e.g. the Pareto distribution.

A histogram is a graphical representation of the frequency distribution of cardinally scaled features. An analysis is a systematic examination of an object that is regularly broken down into its components during the analysis.

Correlations of this measurement data can be taken into account as part of the pre-processing of the measurement data.

In a further step of the presented method, search patterns can be created. These search patterns can take into account the greatest deviation from the estimated probability distribution function (PDF), the largest value in the histogram, and systematic subfunctions in the histogram. Furthermore, the greatest influence on the confidence interval and/or the greatest influence on the determinability of the histogram parameters can be taken into account.

The presented method thus provides a projection of the provided measurement data onto a larger data set. This requires consideration of technical circumstances and aspects. In particular, the coverage of important scenarios can be considered, for example, an urban environment and other interfering influences, the geographic location, especially the latitude, the speed range, interferences due to ground conditions, e.g. cobblestones, the installation space of the sensor, in particular the vibration properties of the bracket.

The described assembly is configured so as to carry out the method presented here. The assembly can be implemented in hardware and/or software. In one embodiment, the assembly is given as a software tool. This is also referred to herein as a histogram analysis tool. This histogram analysis tool represents an innovative tool that is particularly useful in connection with the aforementioned identification of critical and less critical scenarios. It is shown that identifying critical and less critical scenarios of monitored data can be an essential part of validating the safety of the Intended Functionality (SOTIF) in autonomous driving systems, in particular in autonomously driven vehicles.

The featured histogram analysis tool is directed at the following question:

Which driving scenarios have a significant influence on the probability of error?

Various aspects of this question can be considered:
1. Which scenarios deviate most from the estimated probability distribution function (PDF)?
2. Which scenarios result in an error request being violated while using the estimated probability?
3. What scenarios are of significant interest, for example an unexpected peak in the histogram?

The histogram analysis tool inputs are:

measurement data of a test drive,
an acceptance to the PDF,
the error rate assumption.

The output of the histogram analysis tool is:
a list of critical/less critical event data including the start time and the end time of the event.

The presented assembly can be implemented in a hardware and/or software and comprises an evaluation unit that is configured so as to carry out the method described herein.

The described computer program implements the aforementioned software and has program code for carrying out the described method. This computer program can be stored on a machine-readable storage medium.

Further advantages and embodiments of the disclosure are shown in the description and the included drawings.

It is understood that the abovementioned features and those to be explained below can be used not only in the combination indicated in each case, but also in other combinations or on their own, without departing from the scope of the present disclosure.

### BRIEF DESCRIPTION OF THE DRAWINGS

FIG. 1 shows a flow chart of a possible sequence of the presented method.

FIG. 2 shows a schematic representation of a vehicle having an assembly for carrying out the method.

### DETAILED DESCRIPTION

The disclosure is illustrated schematically by way of embodiments in the drawings and is described in detail below with reference to the drawings.

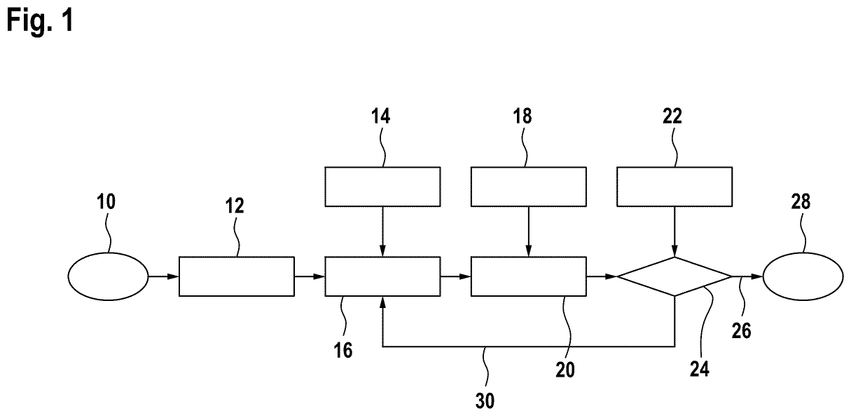

FIG. 1 shows a flow chart of a possible sequence for analysis of a histogram that is performed e.g. using a histogram analysis tool. The method is carried out as part of the evaluation of measurement data. In a first step 10, measurement data is input, which is obtained, for example, in a sample or test drive. Then, in a step 12, a pre-processing or pre-filtering of the measurement data occurs. In the context of this pre-processing, the measurement data is evaluated, e.g. with regard to a resolution of the correlation of the data, wherein a high correlation is classified as disadvantageous. A histogram can be generated based on the measurement data pre-processed in this manner.

Specific requirements for the safety of the intended functionality (SOTIF) that go beyond the possible error rate should be considered, such as the time to alert (TTA), the possible duration of the event, and the possible temporal sequence of the events. In addition, it must be taken into account that the data can be not only temporally but also spatially correlated.

A PDF model is then adopted in a step 14, and a model of a probability distribution function is thus proposed. With the addition of the pre-processed measurement data from step 12, an estimate of the probability distribution function (PDF) is then performed in step 16.

Search patterns are included in a step 18 with regard to the greatest deviation from estimated PDF, greatest values in the histogram and systematic sub-functions in the histogram. Taking into account these search patterns, data samples are eliminated in a step 20 according to the patterns, for example, from the largest to the smallest. This means that the cases that can have the greatest influence are considered first, and it is checked whether measures can be found to eliminate them, e.g. errors in the reference system used as the evaluation.

In a step 22, termination criteria are determined. These are, for example:
an estimated error probability of the PDF reaches a specification, in this case the SOTIF error rate, e.g. 10⁻⁵/h, or a PDF distance to the confidence interval reaches a certain threshold value. The confidence interval represents a range around the expected value of the error rate.

It is then checked in step 24 whether a termination criterion is met. If this is the case (arrow 26), then the data is output in step 28. If this is not the case (arrow 30), then a jump to step 16 takes place.

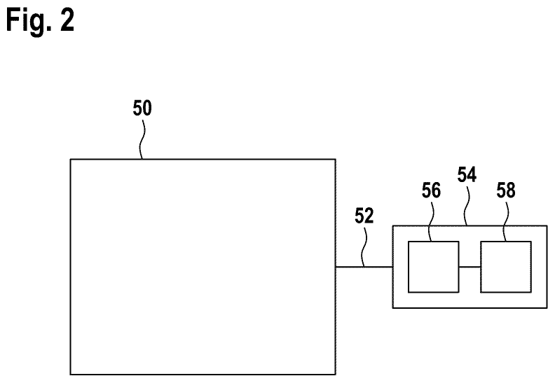

FIG. 2 shows a schematic, highly simplified representation of a vehicle, in particular a motor vehicle, which is labeled overall with the reference number 50. This vehicle 50 provides measurement data 52 during a test drive or test run, which is submitted to an assembly 54 for carrying out the method presented herein. For this purpose, the assembly 54 has an evaluation unit and/or a computing unit 56.

The assembly 54 is configured so to evaluate the obtained measurement data 52 in order to determine, if applicable, that still further data are required for a reliable evaluation of this measurement data 52. These can then be requested. A histogram 58 is generated as part of the evaluation of the measurement data 52 and for further assessment of this measurement data 52.

The request for further measurement data is carried out by systematically covering the scenarios, in which a sub-representation for the application case is to be avoided.

The method presented is based on the recognition that there is a need for innovative methods for SOTIF validation and that this need requires new evaluation methods and analysis methods. The proposed validation is based on a statistical evaluation of limited data sets. This creates the need for methods to identify fewer critical scenarios, the so-called special cases, which stand out from the data sets.

The histogram analysis tool provides an opportunity to identify scenarios that are less critical, wherein different search patterns as well as termination criteria are used. There is a clear definition of scenarios that endanger the SOTIF specification.

What is claimed is:

1. A method of evaluating measurement data for a vehicle, comprising:
providing the measurement data;
pre-processing the measurement data;
creating a histogram for the pre-processed measurement data;
providing a model of a probability distribution function;
estimating the probability distribution function obtained from the measurement data based on the provided model;
providing search patterns; and
eliminating measurement data while taking into account the search patterns.

2. The method according to claim 1, wherein correlations of the measurement data are considered as part of the pre-processing of the measurement data.

3. The method according to claim 1, further comprising creating the search patterns.

4. The method according to claim 3, wherein the search patterns take into account the following:
greatest deviation from the estimated PDF,
greatest values in the histogram,
systematic sub-functions in the histogram,
greatest influence on the confidence interval, and
greatest influence on the determinability of the histogram parameters.

5. The method according to claim 1, further comprising checking termination criteria, wherein:
the measurement data is output when one of the termination criteria is satisfied.

6. The method according to claim 5, wherein the termination criteria are selected from a group consisting of:
an estimated probability of error the PDF reaches a specification, and
a PDF distance to the confidence interval reaches a determined threshold value.

7. The method according to claim 1, wherein it is found that additional measurement data must be provided and is then requested.

8. An assembly for evaluating measurement data having an evaluation unit which is configured so as to carry out a method according to claim 1.

9. A computer program having program code configured so as to carry out a method according to claim 1 when the computer program is executed on a computing unit.

10. A machine-readable storage medium having a computer program according to claim 9 stored thereon.
